(19) United States
(12) Patent Application Publication
(10) Pub. No.: US 2026/0071606 A1
(43) Pub. Date: Mar. 12, 2026

(54) AXIAL PISTON DEVICE

(71) Applicant: KUBOTA CORPORATION, Osaka (JP)

(72) Inventors: Ryoji INAZAWA, Osaka (JP); Rei OKUMA, Osaka (JP); Kenshi FUJIMOTO, Osaka (JP)

(73) Assignee: KUBOTA CORPORATION, Osaka (JP)

(21) Appl. No.: 19/129,364

(22) PCT Filed: Feb. 16, 2024
(86) PCT No.: PCT/JP2024/005444

§ 371 Date: May 13, 2025

(30) Foreign Application Priority Data
Dec. 22, 2022 (JP) 2022-205590

(51) Int. Cl. F03C 1/22; F04B 1/2035; F04B 1/2078

(52) U.S. Cl. CPC F03C 1/223; F04B 1/2035; F04B 1/2078

(57) ABSTRACT

Noise from an axial piston device for use as, for example, a hydraulic pump or a hydraulic motor of a continuously variable hydrostatic transmission is suppressed. A port block includes a supply and discharge port surface section with which a cylinder block is configured to come into contact while rotating, a first port and a second port. In at least one of a first dead center portion and a second dead center portion, the supply and discharge port surface section has a recess extending from one of the first port and the second port that is located on a downstream side in a rotation direction of the cylinder block, toward an upstream side in the rotation direction of the cylinder block.

### TECHNICAL FIELD

The present invention relates to an axial piston device for use as, for example, a hydraulic pump or a hydraulic motor of a continuously variable hydrostatic transmission.

### BACKGROUND ART

A port block of the axial piston device disclosed in Patent Document 1 includes a supply and discharge port surface section, and a first port and a second port that are formed in the supply and discharge port surface section. A cylinder block includes a cylinder port surface, a plurality of cylinder chambers, a plurality of pistons, and a plurality of cylinder ports extending from the cylinder port surface to the corresponding cylinder chambers.

Assuming, as the axial piston device disclosed in Patent Document 1, a hydraulic pump whose cylinder block is driven to rotate by external power, attention is directed to a set of a cylinder port, a cylinder chamber, and a piston.

In a phase in which the cylinder port is opposed to the first port, the piston moves in a direction away from the cylinder port, thereby causing hydraulic fluid to be sucked from the first port into the cylinder chamber through the cylinder port. In a phase in which the cylinder port is opposed to the second port, the piston moves in a direction toward the cylinder port, thereby causing the hydraulic fluid in the cylinder chamber to be ejected to the second port though the cylinder port.

In this case, the pressure in the first port from which the hydraulic fluid is sucked into the cylinder chamber is low, and the pressure in the second port from which the hydraulic fluid is ejected from the cylinder chamber is high.

### PRIOR ART DOCUMENTS

### Patent Documents

Patent Documents 1: JP 2022-11098A

### DISCLOSURE OF THE INVENTION

### Problem to Be Solved by the Invention

In Patent Document 1, in response to the cylinder port moving from the low pressure first port to the high-pressure second port, the cylinder port transitions from a state of being connected to the low pressure first port to a state of being closed by the supply and discharge port surface section of the port block.

As described previously, in response to the cylinder port from moving from the state of being connected to the low pressure first port to the state of being closed by the supply and discharge port surface section, the area of communication between the cylinder port and the low pressure first port gradually decreases, as a result of which the pressure in the cylinder chamber may rapidly drop. The occurrence of such a state results in an increase in noise from the axial piston device, and therefore there is room for improvement.

In Patent Document 1, in response to the cylinder port moving from the high-pressure second port to the low pressure first port, the cylinder port transitions from a state of being connected to the high-pressure second port to the state of being closed by the supply and discharge port surface section of the port block.

As described previously, in response to the cylinder port moving from the state of being connected to the high-pressure second port to the state of being closed by the supply and discharge port surface section, the area of communication between the cylinder port and the high-pressure second port gradually decreases, as a result of which the pressure in the cylinder chamber may rapidly rise. The occurrence of such a state results in an increase in noise from the axial piston device, and therefore there is room for improvement.

An object of the present invention is to suppress noise from an axial piston device for use as, for example, a hydraulic pump or a hydraulic motor of a continuously variable hydrostatic transmission.

### Means for Solving Problem

An axial piston device according to the present invention includes: a port block; a cylinder block that is rotatable relative to the port block; and a swash plate, wherein the port block includes: a supply and discharge port surface section with which the cylinder block is configured to come into contact while rotating; a first port in a portion of the supply and discharge port surface section which portion is located on a first side of a virtual line passing through a rotation axis of the cylinder block at a right angle; and a second port in a portion of the supply and discharge port surface section which portion is located on a second side of the virtual line, the cylinder block includes: a cylinder port surface configured to come into contact with the supply and discharge port surface section; a plurality of cylinder chambers; a plurality of pistons provided inside the respective cylinder chambers in such a manner as to be reciprocable along the rotation axis; and a plurality of cylinder ports extending from the cylinder port surface to the respective cylinder chambers, the swash plate is configured to: in response to the cylinder block being driven to rotate, guide the pistons in such a manner as to cause the pistons to be driven to be reciprocated; or cause the pistons to be driven to be reciprocated as a result of hydraulic fluid being supplied to or discharged from the cylinder chambers to cause the cylinder block to be driven to rotate, the cylinder ports in a phase to face the first port cause the pistons to move in a direction away from the cylinder ports to cause the hydraulic fluid to flow from the first port into the cylinder chambers through the respective cylinder ports, the cylinder ports in a phase to face the second port cause the pistons to move in a direction toward the cylinder ports to cause the hydraulic fluid to flow out of the cylinder chambers through the respective cylinder ports to the second port, the virtual line extends through (i) a first dead center portion that is between the first port and the second port and that is on a first side and (ii) a second dead center portion that is between the first port and the second port and that is on a second side, and the supply and discharge port surface section has in at least one of the first dead center portion and the second dead center portion a at least one a recess extending from a first one of the first port and the second port, the first one being located on a downstream side in a rotation direction of the cylinder block, toward an upstream side in the rotation direction of the cylinder block.

According to the present invention, assuming a hydraulic pump, in response to the cylinder block being driven to rotate by external power, the pistons are guided and driven to be reciprocated by the swash plate.

According to the present invention, assuming a hydraulic motor, as a result of hydraulic fluid from a hydraulic pump being supplied to and discharged from the cylinder chambers, the pistons are driven to be reciprocated by the swash plate, thereby causing the cylinder block to be driven to rotate.

According to the present invention, in a phase in which the cylinder ports are opposed to the first port, the pistons move in a direction away from the cylinder ports, thereby causing the hydraulic fluid to flow from the first port into the cylinder chambers through the cylinder ports. In a phase in which the cylinder ports are opposed to the second port, the pistons move in a direction toward the cylinder ports, thereby causing the hydraulic fluid in the cylinder chamber to flow out to the second port through the cylinder ports.

According to the present invention, assuming a hydraulic pump, in the case where the first dead center portion in which the cylinder ports move from the first port to the second port includes a recess, even if the pressure in the cylinder chambers starts to drop rapidly when the cylinder ports move from the low pressure first port to the high-pressure second port, the cylinder ports immediately reach the recess, thereby causing a state in which the cylinder ports and the high-pressure second port are connected via the recess. Accordingly, the rapid drop in pressure in the cylinder chambers can be prevented.

Thereafter, the cylinder ports are connected to the second port, and the pistons move in a direction toward the cylinder ports, thereby causing the hydraulic fluid in the cylinder chambers to flow out to the second port through the cylinder ports.

According to the present invention, assuming a hydraulic pump, in the case where the second dead center portion in which the cylinder ports move from the second port to the first port includes a recess, even if the pressure in the cylinder chambers starts to rise rapidly when the cylinder ports move from the high pressure second port to the low pressure first port, the cylinder ports immediately reach the recess, thereby causing a state in which the cylinder ports and the low pressure first port are connected via the recess. Accordingly, the rapid rise in pressure in the cylinder chambers can be prevented.

Thereafter, the cylinder ports are connected to the first port, and the pistons move in a direction away from the cylinder port, thereby causing the hydraulic fluid to flow from the first port into the cylinder chambers through the cylinder ports.

According to the present invention, assuming a hydraulic motor, in the case where the first dead center portion in which the cylinder ports move from the first port to the second port includes a recess, even if the pressure in the cylinder chambers starts to rise rapidly when the cylinder ports move from the high-pressure first port to the low pressure second port, the cylinder ports immediately reach the recess, thereby causing a state in which the cylinder ports and the low pressure second port are connected via the recess. Accordingly, the rapid rise in pressure in the cylinder chambers can be prevented.

Thereafter, the cylinder ports are connected to the second port, and the pistons move in a direction toward the cylinder ports, thereby causing the hydraulic fluid in the cylinder chambers to flow out to the second port through the cylinder ports.

According to the present invention, assuming a hydraulic motor, in the case where the second dead center portion in which the cylinder ports move from the second port to the first port includes a recess, even if the pressure in the cylinder chambers starts to drop rapidly when the cylinder ports move from the low pressure second port to the high-pressure first port, the cylinder ports immediately reach the recess, thereby causing a state in which the cylinder ports and the high-pressure first port are connected via the recess. Accordingly, the rapid drop in pressure in the cylinder chambers can be prevented.

Thereafter, the cylinder ports are connected to the first port, and the pistons move in a direction away from the cylinder port, thereby causing the hydraulic fluid to flow from the first port into the cylinder chambers through the cylinder ports.

According to the present invention, at least one of the first dead center portion in which the cylinder ports move from the first port to the second port, and the second dead center portion in which the cylinder ports move from the second port to the first port includes the recess.

This can suppress at least one of noise caused by a rapid drop in pressure in the cylinder chambers, and noise caused by a rapid rise in pressure in the cylinder chambers, thus making it possible to suppress the noise from the axial piston device.

In the present invention, it is preferable that the at least one recess has a dimension along the rotation direction of the cylinder block which dimension allows the cylinder ports to be connected both to a second one of the first port and the second port, the second one being located on the upstream side in the rotation direction of the cylinder block, and to at least one the recess.

According to the present invention, assuming a hydraulic pump, in the case where the first dead center portion in which the cylinder ports move from the first port to the second port includes the recess, the cylinder ports reach the recess while still being connected to the first port when the cylinder ports move from the low pressure first port to the high pressure second port, thereby causing the cylinder ports and the high-pressure second port to be connected via the recess, resulting in a state in which the cylinder ports are connected both to the low pressure first port and to the high pressure second port (recess).

This can further prevent a rapid drop in pressure in the cylinder chambers, and is therefore advantageous in suppressing the noise from the axial piston device.

According to the present invention, assuming a hydraulic pump, in the case where the second dead center portion in which the cylinder ports move from the second port to the first port includes a recess, the cylinder ports reach the recess while still being connected to the second port when the cylinder ports move from the high-pressure second port to the low pressure first port, thereby causing the cylinder ports and the low pressure first port to be connected via the recess, resulting in a state in which the cylinder ports are connected both to the high-pressure second port and to the low pressure first port (recess).

This can further prevent a rapid rise in pressure in the cylinder chambers, and is therefore advantageous in suppressing the noise from the axial piston device.

According to the present invention, assuming a hydraulic motor, in the case where the first dead center portion in which the cylinder ports move from the first port to the second port includes a recess, the cylinder ports reach the recess while still being connected to the first port when the cylinder ports move from the high-pressure first port to the low pressure second port, thereby causing the cylinder ports and the low pressure second port to be connected via the recess, resulting in a state in which the cylinder ports are connected both to the high pressure first port and to the low pressure second port (recess).

This can further prevent a rapid rise in pressure in the cylinder chambers, and is therefore advantageous in suppressing the noise from the axial piston device.

According to the present invention, assuming a hydraulic motor, in the case where the second dead center portion in which the cylinder ports move from the second port to the first port includes the recess, the cylinder ports reach the recess while still being connected to the second port when the cylinder ports move from the low pressure second port to the high-pressure first port, thereby causing the cylinder ports and the high-pressure first port to be connected via the recess, resulting in a state in which the cylinder ports are connected both to the low pressure second port and to the high-pressure first port (recess).

This can further prevent a rapid drop in pressure in the cylinder chambers, and is therefore advantageous in suppressing the noise from the axial piston device.

In the present invention, it is preferable that virtual arrangement lines extending through respective centers of the cylinder ports in the rotation direction of the cylinder block and the rotation axis have, as spaces between arrangement virtual lines of adjacent ones among the cylinder ports, arrangement pitches at least one of which is different from another.

In a hydraulic pump (hydraulic motor), in response to the cylinder ports moving from the first port to the second port (in response to the cylinder ports moving from the second port to the first port), vibrations attributed to a pressure change may be generated in the cylinder chambers and the pistons as a result of the supply/discharge state of the hydraulic fluid being switched between the cylinder port and the first port and the second hydraulic port. When vibration phases in a plurality of cylinder chambers and pistons match, the vibrations may be amplified, thus causing noise.

According to the present invention, in the cylinder block, the arrangement pitches of the cylinder ports are not all the same, but includes arrangement pitches that are different from each other.

This makes it possible to shift the above-described vibration phases in the cylinder ports having different arrangement pitches to avoid the amplification of vibrations, and is therefore advantageous in suppressing the noise from the axial piston device.

In the case where the arrangement pitches of the cylinder ports include arrangement pitches that are different from each other as described previously, after one cylinder port has passed through the first dead center portion (second dead center portion), the subsequent cylinder port may reach the first dead center portion (second dead center portion) earlier, or reach the first dead center portion (second dead center portion) later.

According to the present invention, the formation of the recess in the first dead center portion (second dead center portion) makes it possible to easily achieve a state in which the cylinder ports and the high-pressure (low-pressure) second port are connected via the recess (state in which the cylinder ports and the low pressure (high-pressure) first port are connected via the recess) even if a cylinder port subsequent to one cylinder port reaches the first dead center portion (second dead center portion) earlier, or reaches the first dead center portion (second dead center portion) later.

This makes it possible to easily achieve a state in which the cylinder ports and the high pressure (low pressure) second port are connected via the recess (state in which the cylinder ports and the low pressure (high-pressure) first port are connected via the recess), and to avoid the amplification of vibrations in the cylinder chambers and the pistons, and is therefore advantageous in suppressing the noise from the axial piston device.

In the present invention, it is preferable that virtual arrangement lines extending through respective centers of the cylinder ports in the rotation direction of the cylinder block and the rotation axis have, as spaces between arrangement virtual lines of adjacent ones among the cylinder ports, arrangement pitches all of which are different from one another.

In a hydraulic pump (hydraulic motor), in response to the cylinder ports moving from the first port to the second port (in response to the cylinder ports moving from the second port to the first port), vibrations attributed to a pressure change may be generated in the cylinder chambers and the pistons as a result of the supply/discharge state of the hydraulic fluid being switched between the cylinder port and the first port and the second hydraulic port. When vibration phases in a plurality of cylinder chambers and pistons match, the vibrations may be amplified, thus causing noise.

According to the present invention, in the cylinder block, the arrangement pitches of the cylinder ports are all different from each other.

This makes it possible to shift the above-described vibration phases in all of the cylinder ports to avoid the amplification of vibrations, and is therefore advantageous in suppressing the noise from the axial piston device.

In the case where the arrangement pitches of the cylinder ports are all different from each other as described previously, after one cylinder port has passed through the first dead center portion (second dead center portion), the next cylinder port may reach the first dead center portion (second dead center portion) earlier, or reach the first dead center portion (second dead center portion) later.

According to the present invention, the formation of the recess in the first dead center portion (second dead center portion) makes it possible to easily achieve a state in which the cylinder ports and the high pressure (low-pressure) second port are connected via the recess (state in which the cylinder ports and the low pressure (high-pressure) first port are connected via the recess) even if a cylinder port subsequent to one cylinder port reaches the first dead center portion (second dead center portion) earlier, or reaches the first dead center portion (second dead center portion) later.

This makes it possible to easily achieve a state in which the cylinder ports and the high-pressure (low pressure) second port are connected via the recess (state in which the cylinder ports and the low pressure (high-pressure) first port are connected via the recess), and to avoid the amplification of vibrations in the cylinder chambers and the pistons, and is therefore advantageous in suppressing the noise from the axial piston device.

In the present invention, it is preferable that the at least one recess includes a recess at the first dead center portion and a recess at the second dead center portion.

According to the present invention, both the first dead center portion and the second dead center portion include the recess, and this makes it possible to suppress both noise attributed to a rapid drop in pressure in the cylinder chambers, and noise attributed to a rapid rise in pressure in the cylinder chambers, and is therefore advantageous in suppressing the noise from the axial piston device.

In the present invention, it is preferable that the cylinder block is drivable to rotate in one direction by external power, the swash plate is configured, in response to the cylinder block being driven to rotate, guide the pistons in such a manner as to cause the pistons to be driven to be reciprocated, and the swash plate is switchable between a forward rotation position at which the cylinder ports in the phase to face the first port cause the pistons to move in the direction away from the cylinder ports, and the cylinder ports in the phase to face the second port cause the pistons to move in the direction toward the cylinder ports, and a reverse rotation position at which the cylinder ports in the phase to face the first port cause the pistons to move in the direction toward the cylinder ports, and the cylinder ports in the phase to face the second port cause the pistons to move in the direction away from the cylinder ports.

According to the present invention, the axial piston device is a hydraulic motor. In response to the cylinder block being driven to rotate by external power, the pistons are guided and driven to be reciprocated by the swash plate. The swash plate is switchable between the forward rotation position and the reverse rotation position.

In response to the swash plate being operated to the forward rotation position, the pistons move in the direction away from the cylinder ports in the phase in which the cylinder ports are opposed to the first port, thereby causing the hydraulic fluid to flow from the first port into the cylinder chambers through the cylinder ports. The pistons move in the direction toward the cylinder ports in the phase in which the cylinder ports are opposed to the second port, thereby causing the hydraulic fluid in the cylinder chambers to flow out to the second port through the cylinder ports.

In response to the swash plate being operated to the reverse rotation position, the pistons move in the direction toward the cylinder ports in the phase in which the cylinder ports are opposed to the first port, thereby causing the hydraulic fluid in the cylinder chamber to flow out to the first port through the cylinder ports. The pistons move in the direction away from the cylinder ports in the phase in which the cylinder ports are opposed to the second port, thereby causing the hydraulic fluid to flow from the second port into the cylinder chambers through the cylinder ports.

According to the present invention, both the first dead center portion and the second dead center portion include the recess in the above-described configuration.

In the case where the swash plate is operated to the forward rotation position, it is possible to achieve both a state in which a rapid drop in pressure in the cylinder chambers can be prevented in the first dead center portion in which the cylinder ports move from the first port to the second port, and a state in which a rapid rise in pressure in the cylinder chambers can be prevented in the second dead center portion in which the cylinder ports move from the second port to the first port.

This can prevent a rapid drop and a rapid rise in pressure in the cylinder chambers, and is therefore advantageous in suppressing the noise from the axial piston device.

In the case where the swash plate is operated to the reverse rotation position, it is possible to achieve both a state in which a rapid rise in pressure in the cylinder chambers can be prevented in the first dead center portion in which the cylinder ports move from the first port to the second port, and a state in which a rapid drop in pressure in the cylinder chambers can be prevented in the second dead center portion in which the cylinder ports move from the second port to the first port.

This can prevent a rapid rise and a rapid drop in pressure in the cylinder chambers, and is therefore advantageous in suppressing the noise from the axial piston device.

### BRIEF DESCRIPTION OF THE DRAWINGS

FIG. 1 is a longitudinal sectional side view of a hydraulic pump.

FIG. 2 is a front view of a cylinder port surface of a cylinder block.

FIG. 3 is a front view of a port plate.

FIG. 4 is a cross-sectional view of a cylinder chamber and a front view of a port plate, showing a state in which a cylinder port in phase #1 or #9 reaches a first recess to be connected to the first recess while remaining connected to a first port.

FIG. 5 is a cross-sectional view of a cylinder chamber and a front view of the port plate, showing a state in which a center of the cylinder chamber in the phase #1 or #9 is located on a virtual line in a first dead center portion.

FIG. 6 is a cross-sectional view of a cylinder chamber and a front view of the port plate, showing a state in which a center of a cylinder chamber in phase #2, #4, #6, or #8 is located on a virtual line in the first dead center portion.

FIG. 7 is a cross-sectional view of a cylinder chamber and a front view of the port plate, showing a state in which a center of a cylinder chamber in phase #3, #5, or #7 is located on a virtual line in the first dead center portion.

### BEST MODE FOR CARRYING OUT THE INVENTION

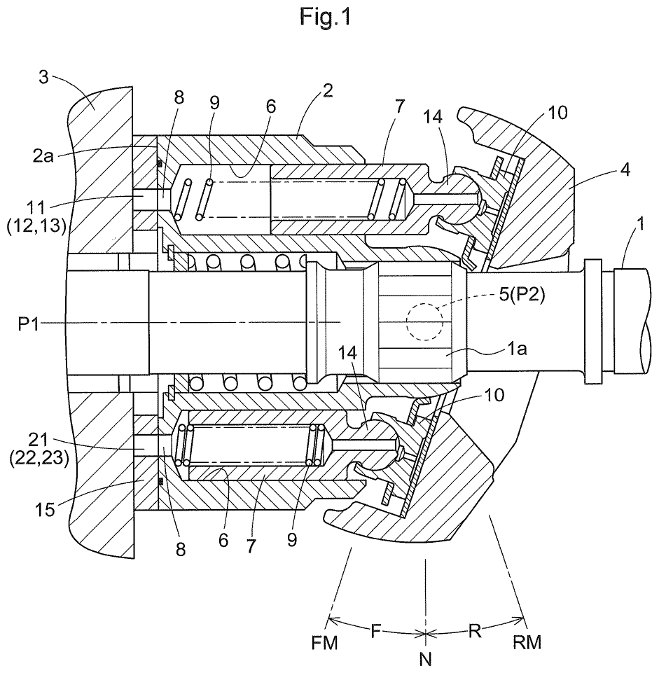

FIGS. 1 to 7 show, as an example of an axial piston device, a hydraulic pump of a continuously variable hydrostatic transmission including the hydraulic pump and a hydraulic motor.

### Overall Configuration of Hydraulic Pump

As shown in FIG. 1, the hydraulic pump includes a drive shaft 1, a cylinder block 2, cylinder chambers 6 and pistons 7, a port block 3, and a swash plate 4.

The drive shaft 1 extends through and is supported by a port block 3 in such manner as to be rotatable about an axis P1.

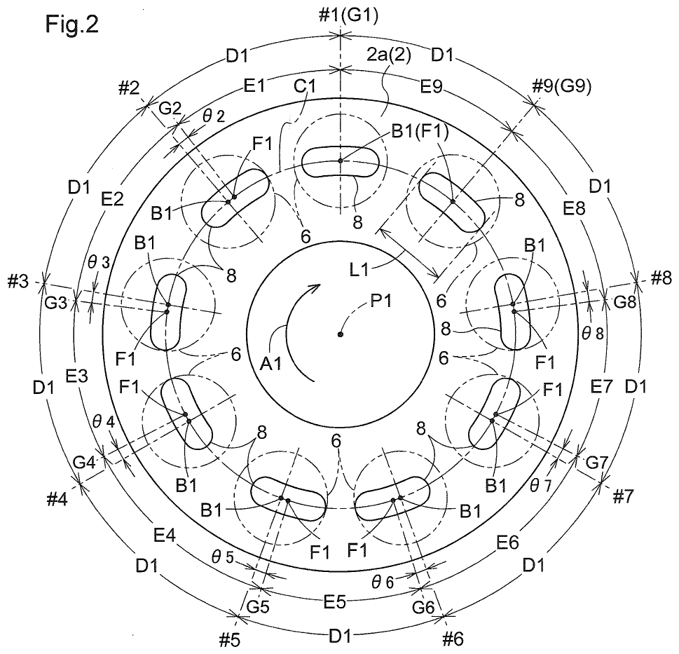

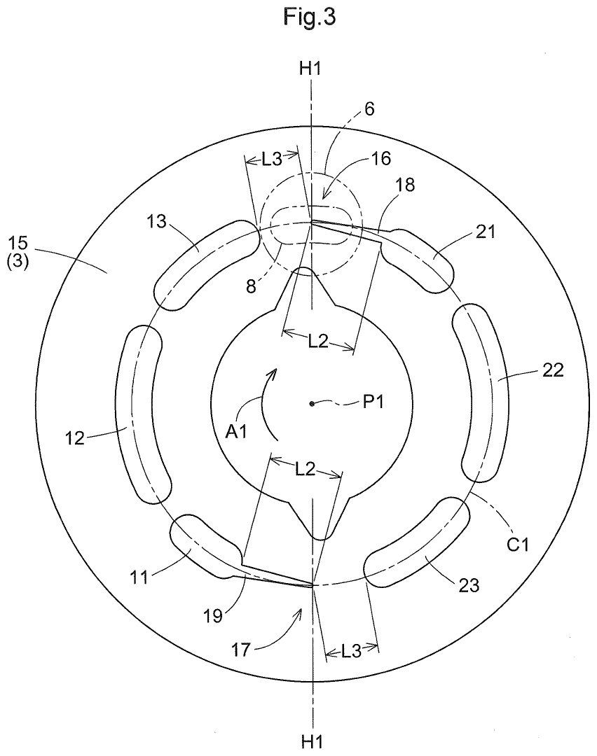

The drive shaft 1 is driven to rotate in one direction in a rotation direction A1 (see FIGS. 2 and 3) by external power of an engine (not shown), an electric motor (not shown), or the like.

A circular port plate 15 (corresponding to a supply and discharge port surface section) is attached to the port block 3, and the port block 3 includes first ports 11, 12, and 13, and second ports 21, 22, and 23 (see FIG. 3).

The cylinder block 2 is coupled to a spline portion 1a of the drive shaft 1. The cylinder block 2 includes the cylinder chambers 6 and the pistons 7. As a result of the drive shaft 1 being driven to rotate in one direction, the cylinder block 2 (the cylinder chambers 6 and the pistons 7) is driven to rotate in one direction in the rotation direction A1 (see FIG. 2) about the axis P1 (corresponding to a rotation axis) together with the drive shaft 1.

The swash plate 4 is supported in such a manner that the drive shaft 1 passes through the swash plate 4, and an end portion of the piston 7 is in contact with the swash plate 4. In response to the cylinder block 2 being driven to rotate, the swash plate 4 causes the pistons 7 to reciprocate inside the cylinder chambers 6.

With the above-described configuration, the port block 3, the cylinder block 2 that is rotatable relative to the port block 3, and the swash plate 4 are provided.

### Configuration of Cylinder Block

As shown in FIGS. 1 and 2, the cylinder block 2 includes nine cylinder chambers 6 along the axis P1. Assuming a virtual circle C1 around the axis P1, a center B1 of each of the cylinder chambers 6 is located on the virtual circle C1.

A cylinder port surface 2a is formed on an end portion of the cylinder block 2, and oblong cylinder ports 8 extend between the cylinder port surface 2a of the cylinder block 2 and the cylinder chambers 6 in such a manner as to respectively correspond to the cylinder chambers 6.

In the case where phases #1 to #9 (radial directions of the cylinder block 2 passing through the axis P1) in which the center B1 of the cylinder chambers 6 are located are assumed around the axis P1 of the cylinder block 2, arrangement pitches D1, which are spaces between the adjacent phases #1 to #9 are all the same.

The pistons 7 are provided inside the respective cylinder chambers 6, and the pistons 7 are reciprocable along the axis P1. In each of the cylinder chambers 6, a spring 9 is provided extending from an end portion of the cylinder chamber 6 to the corresponding piston 7, and the piston 7 is biased in a direction away from the cylinder port 8 by the springs 9.

### Configuration of Cylinder Ports in Cylinder Block

As shown in FIG. 2, each of the cylinder ports 8 has an oval shape, is provided at a position on the virtual circle C1 along the virtual circle C1, and is bent in an arc shape. Alength L1 (length along the virtual circle C1) of the cylinder port 8 along the rotation direction A1 is the same for all of the cylinder ports 8.

The relationship between the center F1 (the center in a direction extending along the virtual circle C1) of the rotation direction A1 of the cylinder port 8, and the center B1 of the cylinder chamber 6 will be described below.

In the phases #1 and #9, the center B1 of the cylinder chamber 6 coincides with a center F1 of the corresponding cylinder port 8. Accordingly, assuming arrangement virtual lines G1 and G9 that pass through the centers F1 of the respective cylinder ports 8 and the axis P1, the phase #1 and the arrangement virtual line G1 coincide with each other, and the phase #9 and the arrangement virtual line G9 coincide with each other.

In the phases #2, #4, #6, and #8, assuming arrangement virtual lines G2, G4, G6, and G8 that pass through the centers F1 of the respective cylinder ports 8 and the axis P1, the arrangement virtual lines G2, G4, G6, and G8 are located on a leading side (downstream side) in the rotation direction A1 relative to the phase #2, #4, #6, and #8, respectively, by phase angle differences θ2, θ4, θ6, and θ8, respectively.

In the phases #3, #5, and #7, assuming arrangement virtual lines G3, G5, and G7 that pass through the center F1 of the cylinder port 8 and the axis P1, the arrangement virtual lines G3, G5, and G7 are located on a lagging side (upstream side) in the rotation direction A1 relative to the phases #3, #5, and #7, respectively, by phase angle differences θ3, θ5, and θ7, respectively.

All the phase angle differences θ2 to θ8 are set to values that are different from each other.

Thus, arrangement pitches E1 to E9, more specifically, an arrangement pitch E1 that is a space between the arrangement virtual lines G1 and G2, an arrangement pitch E2 that is a space between the arrangement virtual lines G2 and G3, an arrangement pitch E3 that is a space between the arrangement virtual lines G3 and G4, an arrangement pitch E4 that is a space between the arrangement virtual lines G4 and G5, an arrangement pitch E5 that is a space between the arrangement virtual lines G5 and G6, an arrangement pitch E6 that is a space between the arrangement virtual lines G6 and G7, an arrangement pitch E7 that is a space between the arrangement virtual lines G7 and G8, an arrangement pitch E8 that is a space between the arrangement virtual lines G8 and G9, and an arrangement pitch E9 that is a space between the arrangement virtual lines G9 and G1 all have values that are different from each other.

With the above-described configuration, for the arrangement virtual lines G1 to G9 that pass through the centers B1 of the respective cylinder ports 8 in the rotation direction A1 of the cylinder block 2 and the axis P1 (the rotation axis), all of the arrangement pitches E1 to E9 that are spaces between the arrangement virtual lines G1 to G9 of the adjacent cylinder ports 8 are different from each other.

### Configuration of Port Block

As shown in FIG. 3, in the port plate 15 attached to the port block 3, assuming a virtual line H1 passing through the axis P1 at a right angle (diametrically around the axis P1), three first ports 11, 12, and 13 are formed in a portion of the port plate 15 that is located on one side (the left side in FIG. 3) relative to the virtual line H1. Three second ports 21, 22, and 23 are formed in a portion of the port plate 15 that is located on the other side (the left side in FIG. 3) relative to the virtual line H1.

The first ports 11, 12, and 13, and the second ports 21, 22, and 23 have an oval shape, are provided at positions on the virtual circle C1 along the virtual circle C1 (see FIG. 2), and are bent in an arc shape. The first ports 11, 12, and 13 and the second ports 21, 22, and 23 are point-symmetrical about the axis P1.

A first dead center portion 16 is a portion of the port plate 15 that is located between the first port 13 and the second port 21 and through which the virtual line H1 passes, and a second dead center portion 17 is a portion of the port plate 15 that is located between the first port 11 and the second port 23 and through which the virtual line H1 passes.

At the first dead center portion 16 of the port plate 15, a cross-sectionally V-shaped first recess 18 (corresponding to a recess) is formed from the second port 21 (corresponding to one of the first port 13 and the second port 21 that is located on the downstream side in the rotation direction A1 of the cylinder block 2) toward the first port 13 (corresponding to the other of the first port 13 and the second port 21 that is located on the upstream side in the rotation direction A1 of the cylinder block 2).

At the second dead center portion 17 of the port plate 15, a cross-sectionally V-shaped second recess 19 (corresponding to a recess) is formed from the first port 11 (corresponding to one of the first port 11 and the second port 23 that is located on the downstream side in the rotation direction A1 of the cylinder block 2) toward the second port 23 (corresponding to the other of the first port 11 and the second port 23 that is located on the upstream side in the rotation direction A1 of the cylinder block 2).

The first recess 18 and the second recess 19 are provided at positions on the virtual circle C1 along the virtual circle C1. An end portion of the first recess 18 and an end portion of the second recess 19 are located on the virtual line H1. Lengths L2 along rotation direction A1 (lengths along the virtual circles C1) of the first recess 18 and the second recess 19 are the same.

A length L3 along the rotation direction A1 (a length along the virtual circle C1) between the end portion of the first recess 18 and the first port 13 and a length L3 along the rotation direction A1 (the length along the virtual circle C1) between the end portion of the second recess 19 and the second port 23 are the same. The length L3 is shorter than the length L1 (see FIG. 2) of the cylinder port 8 described above.

Thus, the first recess 18 of the first dead center portion 16, the first port 13 and the second port 21, the second recess 19 of the second dead center portion 17, and the first port 11 and the second port 23 are point-symmetrical about the axis P1.

As a result of the cylinder block 2 being driven to rotate as previously described, the cylinder port surface 2a of the cylinder block 2 is driven to rotate in the rotation direction A1 while being in contact with the port plate 15, and the cylinder ports 8 of the cylinder block 2 are connected to the first ports 11, 12, and 13 and second ports 21, 22, and 23 of the port plate 15 (port block 3).

### Configuration of Swash Plate

As shown in FIG. 1, a trunnion shaft 5 is supported pivotably about an axis P2 that is orthogonal to the axis P1, and the swash plate 4 is coupled to the trunnion shaft 5. As a result of the trunnion shaft 5 being operated from the outside, the swash plate 4 is switched between a forward rotation-maximum speed position FM and a reverse rotation-maximum speed position RM from a neutral position N. Any position between the neutral position N and the forward rotation-maximum speed position FM, and the forward rotation-maximum speed position FM are a forward rotation position F. Any position between the neutral position N and the reverse rotation-maximum speed position RM, and the reverse rotation-maximum speed position RM are a reverse rotation position R.

Ring members 10 are provided in such a manner as to be slidable against the swash plate 4 around the axis P1, and the respective end portions of the pistons 7 and the ring members 10 are connected to each other via universal joints 14. In response to the cylinder block 2 (the cylinder chambers 6 and the pistons 7) being driven to rotate, the ring members 10 are driven to rotate together with the cylinder block 2 (the cylinder chambers 6 and the pistons 7), and slide against the swash plate 4 around the axis P1.

In response to the cylinder block 2 being driven to rotate, the swash plate 4 and the springs 9 cause the pistons 7 to reciprocate inside the cylinder chamber 6 along the axis P1 in the manner described below.

### State in Which Swash Plate Is Operated To Forward Rotation Position

The state shown in FIG. 1 is a state in which the swash plate 4 is operated to the forward rotation-maximum speed position FM among the forward rotation positions F.

In the state in which the swash plate 4 is operated to the forward rotation-maximum speed position FM, when a cylinder chambers 6 and the corresponding piston 7 are located on the virtual line H1 in the second dead center portion 17 relative to the port block 3 (the port plate 15) as shown in FIG. 3, the piston 7 is located closest to the cylinder port 8 (see the lower piston 7 in FIG. 1).

As shown in FIGS. 1, 2, and 3, as a result of the cylinder block 2 being driven to rotate in the rotation direction A1, the cylinder chambers 6 and the pistons 7 move from the virtual line H1 in the second dead center portion 17 along the first ports 11, 12, and 13, and the pistons 7 move in a direction away from the cylinder ports 8.

During this period, low pressure hydraulic fluid flows from the first ports 11, 12, and 13 into the cylinder chambers 6 through the cylinder ports 8, and the pressure in the first ports 11, 12, and 13 is reduced. When the cylinder chambers 6 and the pistons 7 are located on the virtual line H1 in the first dead center portion 16, the pistons 7 are located furthest away from the cylinder ports 8 (see the upper piston 7 in FIG. 1).

As a result of the cylinder block 2 being driven to rotate in the rotation direction A1, the cylinder chambers 6 and the pistons 7 move from the virtual line H1 in the first dead center portion 16 along the second ports 21, 22, and 23, and the pistons 7 move in a direction toward the cylinder ports 8. During this period, high-pressure hydraulic fluid in the cylinder chambers 6 flows out to the second ports 21, 22, and 23 through the cylinder ports 8, and the pressure in the second ports 21, 22, and 23 is increased.

When the cylinder chambers 6 and the pistons 7 are located on the virtual line H1 in the second dead center portion 17 in the case where the swash plate 4 is operated to a position among the forward rotation positions F between the neutral position N and the forward rotation-maximum speed position FM, the pistons 7 are located at positions further away from the cylinder ports 8 than the position indicated by the lower piston 7 in FIG. 1. When the cylinder chambers 6 and the pistons 7 are located on the virtual line H1 in the first dead center portion 16, the pistons 7 are located at positions closer to the cylinder ports 8 than the position indicated by the upper piston 7 in FIG. 1.

### State in Which Swash Plate Is Operated To Reverse Rotation Position

In contrast to the state shown in FIG. 1, a state in which the swash plate 4 is operated to the reverse rotation-maximum speed position RM among the reverse rotation positions R is assumed.

As shown in FIGS. 1, 2, and 3, when the cylinder chambers 6 and the pistons 7 are located on the virtual line H1 in the first dead center portion 16 relative to the port block 3 (the port plate 15) in a state in which the swash plate 4 is operated to the reverse rotation-maximum speed position RM, the pistons 7 are located closest to the cylinder ports 8 (see the lower piston 7 in FIG. 1).

As a result of the cylinder block 2 being driven to rotate in the rotation direction A1, the cylinder chambers 6 and the pistons 7 move from the virtual line H1 in the first dead center portion 16 along the second ports 21, 22, and 23, and the pistons 7 move in a direction away from the cylinder ports 8.

During this period, low pressure hydraulic fluid flows from the second ports 21, 22, and 23 into the cylinder chambers 6 through the cylinder ports 8, and the pressure in the second ports 21, 22, and 23 is reduced. When the cylinder chambers 6 and the pistons 7 are located on the virtual line H1 in the second dead center portion 17, the pistons 7 are located furthest away from the cylinder ports 8 (see the upper piston 7 in FIG. 1).

As a result of the cylinder block 2 being driven to rotate in the rotation direction A1, the cylinder chambers 6 and the pistons 7 move from the virtual line H1 in the second dead center portion 17 along the first ports 11, 12, and 13, and the pistons 7 move in a direction toward the cylinder ports 8. During this period, high-pressure hydraulic fluid in the cylinder chambers 6 flows out to the first ports 11, 12, and 13 through the cylinder ports 8, and the pressure in the first ports 11, 12, and 13 is increased.

When the cylinder chambers 6 and the pistons 7 are located on the virtual line H1 in the first dead center portion 16 in the case where the swash plate 4 is operated to a position among the reverse rotation positions R between the neutral position N and the reverse rotation-maximum speed position RM, the pistons 7 are located at positions further away from the cylinder ports 8 than the position indicated by the lower piston 7 in FIG. 1. When the cylinder chambers 6 and the pistons 7 are located on the virtual line H1 in the second dead center portion 17, the pistons 7 are located at positions closer to the cylinder ports 8 than the position indicated by the upper piston 7 in FIG. 1.

### Correspondence Between Cylinder Block and Port Block and Claims

With the foregoing configuration, as shown in FIGS. 1, 2, and 3, the port block 3 includes the port plate 15 (the supply and discharge port surface section) with which the cylinder block 2 is configured to come into contact while rotating, the first ports 11, 12, and 13 that are formed in a portion of the port plate 15 (the supply and discharge port surface section) and located on one side relative to the virtual line H1 passing through the axis P1 (the rotation axis) of the cylinder block 2 at a right angle, and the second ports 21, 22, and 23 that are formed on a portion of the port plate 15 (the supply and discharge port surface section) and located on the other side relative to the virtual line H1.

The cylinder block 2 includes the cylinder port surface 2a configured to come into contact with the port plate 15 (the supply and discharge port surface section), the plurality of cylinder chambers 6, the plurality of pistons 7 provided inside the corresponding cylinder chambers 6 in such a manner as to be reciprocable along the axis P1 (rotation axis), and the plurality of cylinder ports 8 extending from the cylinder port surface 2a to the corresponding cylinder chambers 6. The cylinder block 2 is driven to rotate by external power.

In at least one of the first dead center portion 16 constituting one portion located between the first ports 11 and 13 and the second ports 21 and 23 and through which the virtual line H1 passes, and the second dead center portion 17 constituting another portion located between the first ports 11 and 13 and the second ports 21 and 23 and through which the virtual line H1 passes, the port block 3 includes the following configuration.

The port plate 15 (supply and discharge port surface section) has the first recess 18 (recess) formed therein from the second port 21 (one of the first port 11 or 13 and the second port 21 or 23) that is located on a downstream side in the rotation direction A1 of the cylinder block 2, toward an upstream side in the rotation direction A1 of the cylinder block 2.

The port plate 15 (supply and discharge port surface section) has the second recess 19 (recess) formed therein from the first port 11 (one of the first port 11 or 13 and the second port 21 or 23) that is located on a downstream side in the rotation direction A1 of the cylinder block 2, toward an upstream side in the rotation direction A1 of the cylinder block 2.

### Correspondence Between Swash Plate and Claims

With the foregoing configuration, as shown in FIGS. 1, 2, and 3, the swash plate 4 is configured to, in response to the cylinder block 2 being driven to rotate, guide the pistons 7 in such a manner as to cause the pistons 7 to be driven to be reciprocated.

In response to the swash plate 4 being operated to the forward rotation position F, the pistons 7 move in a direction away from the cylinder ports 8 in the phase in which the cylinder ports 8 are opposed to the first ports 11, 12, and 13, thereby causing the hydraulic fluid to flow from the first ports 11, 12, and 13 into the cylinder chambers 6 through the cylinder ports 8.

The pistons 7 move in a direction toward the cylinder ports 8 in the phase in which the cylinder ports 8 are opposed to the second ports 21, 22, and 23, thereby causing the hydraulic fluid in the cylinder chambers 6 to flow out to the second ports 21, 22, and 23 through the cylinder ports 8.

In response to the swash plate 4 being operated to the reverse rotation position R, the pistons 7 move in a direction toward the cylinder ports 8 in the phase in which the cylinder ports 8 are opposed to the first ports 11, 12, and 13, thereby causing the hydraulic fluid in the cylinder chamber 6 to flow out to the first ports 11, 12, and 13 through the cylinder ports 8.

The pistons 7 move in a direction away from the cylinder ports 8 in the phase in which the cylinder ports 8 are opposed to the second ports 21, 22, and 23, thereby causing the hydraulic fluid to flow from the second ports 21, 22, and 23 into the cylinder chambers 6 through the cylinder ports 8.

Both the first dead center portion 16 and the second dead center portion 17 include the first recess 18 (recess) and the second recess 19 (recess).

### Relationship of Cylinder Ports with First Recess and Second Recess—1

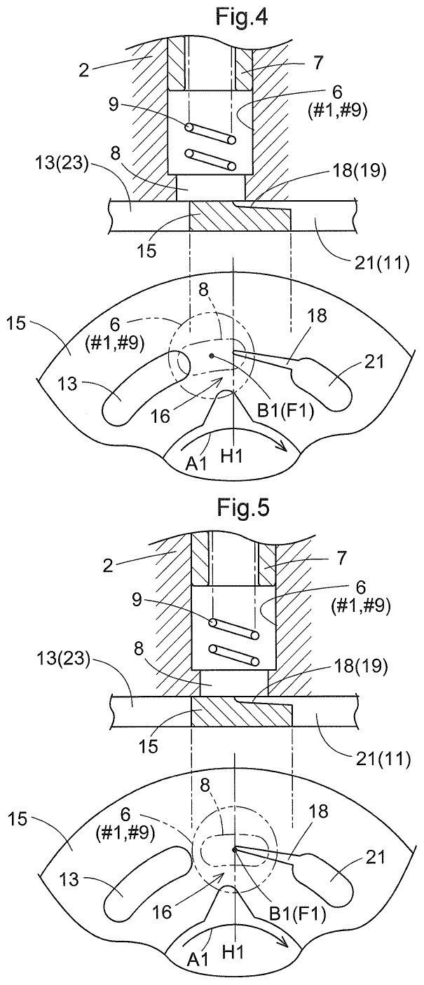

As shown in FIG. 4, in response to the cylinder block 2 being driven to rotate in the rotation direction A1, thereby causing each cylinder chamber 6 and the corresponding piston 7 to move from the first port 13 to the first dead center portion 16, a state occurs in which the cylinder port 8 reaches the first recess 18 to be connected to the first recess 18 while remaining connected to the first port 13.

Thus, the cylinder port 8 is connected to the first port 13, and is also connected to the second port 21 via the first recess 18. Although FIG. 4 shows the cylinder chamber 6 and the piston 7, as well as the cylinder port 8 in the phase #1 or #9 (see FIG. 2), the state shown in FIG. 4 also occurs in the cylinder chambers 6 and the pistons 7, as well as the cylinder ports 8 in the phases #2 to #8.

Also in the case where the cylinder block 2 is driven to rotate in the rotation direction A1, thereby causing the cylinder chambers 6 and the pistons 7 in the phases #1 to #9 to move from the second port 23 to the second dead center portion 17 (see FIG. 3), the cylinder ports 8 are connected to the second ports 23, and are also connected to the first port 11 via the second recesses 19.

This is based on the fact that, as described previously, the length L3 along the rotation direction A1 (the length along the virtual circle C1) between the end portion of the first recess 18 and the first port 13, and the length L3 along the rotation direction A1 (the length along the virtual circle C1) between the end portion of the second recess 19 and the first port 11 are the same (see FIG. 3), and the length L3 is shorter than the above-described length L1 (see FIG. 2) of the cylinder ports 8.

### Relationship of Cylinder Ports with First Recess and Second Recess—2

With the foregoing configuration, as shown in FIGS. 3 and 4, the length L2 of the first recess 18 (recess) along the rotation direction A1 of the cylinder block 2 is set to a length at which a state occurs in which a cylinder port 8 is connected both to the first port 13 (the other of the first port 11 or 13 and the second port 21 or 23) located on the upstream side in the rotation direction A1 of the cylinder block 2, and to the first recess 18 (recess).

As shown in FIGS. 3 and 4, the length L2 of the second recess 19 (recess) along the rotation direction A1 of the cylinder block 2 is set to a length at which a state occurs in which a cylinder port 8 is connected both to the second port 23 (the other of the first port 11 or 13 and the second port 21 or 23) located on the upstream side in the rotation direction A1 of the cylinder block 2, and to the second recess 19 (recess).

### Relationship of Cylinder Ports with First Recess and Second Recess—3

It is assumed that the cylinder block 2 is driven to rotate in the rotation direction A1 from the state shown in FIG. 4, and the center B1 (see FIG. 2) of the cylinder chamber 6 in the phase #1 or #9 is located on the virtual line H1 in the first dead center portion 16 as shown in FIG. 5.

In the state shown in FIG. 5, the center F1 (see FIG. 2) of the cylinder port 8 in the phase #1 or #9 is located on the virtual line H1 in the first dead center portion 16. The cylinder port 8 in the phase #1 or #9 is separated from the first port 13, and the connection portion between the cylinder port 8 in the phase #1 or #9 and the first recess 18 is increased.

Likewise, also in the case where the center B1 of the cylinder chamber 6 in the phase #1 or #9 and the center F1 of the cylinder port 8 have reached the virtual line H1 in the second dead center portion 17 (see FIG. 3), the cylinder port 8 in the phase #1 or #9 is separated from the second port 23, and the connection portion between the cylinder port 8 in the phase #1 or #9 and the second recess 19 (see FIG. 3) is increased.

### Relationship of Cylinder Ports with First Recess and Second Recess—4

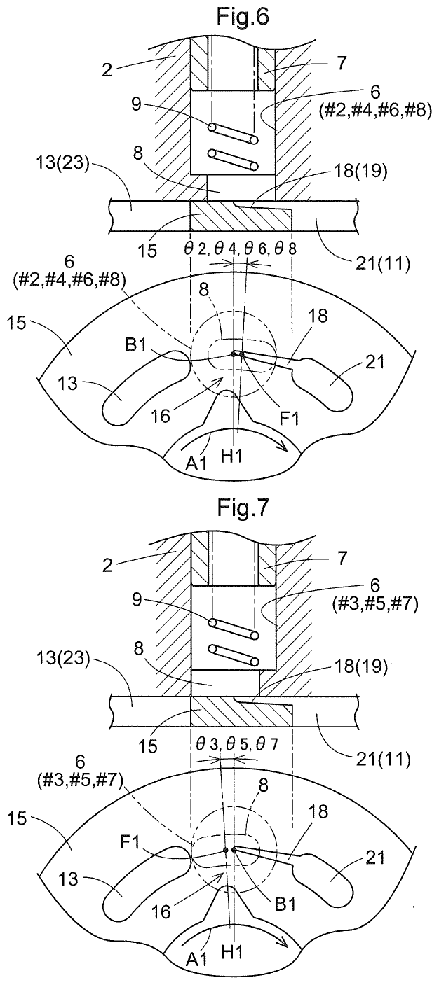

It is assumed that the cylinder block 2 is driven to rotate in the rotation direction A1 from the state shown in FIG. 4, and the center B1 (see FIG. 2) of the cylinder chamber 6 in the phase #2, #4, #6, or #8 is located on the virtual line H1 in the first dead center portion 16 as shown in FIG. 6.

In the state shown in FIG. 6, the center F1 (see FIG. 2) of the cylinder port 8 in the phase #2, #4, #6, or #8 is located on the leading side (downstream side) in the rotation direction A1 relative to the virtual line H1 in the first dead center portion 16 by a phase angle difference θ2, θ4, θ6, or θ8. The cylinder port 8 in the phase #2, #4, #6, or #8 is separated from the first port 13, and the connection portion between the cylinder port 8 in the phase #2, #4, #6, or #8 and the first recess 18 is increased.

Likewise, also in the case where the center B1 of the cylinder chamber 6 in the phase #2, #4, #6, or #8 has reached the virtual line H1 in the second dead center portion 17 (see FIG. 3), the cylinder port 8 in the phase #2, #4, #6, or #8 is separated from the second port 23, and the connection portion between the cylinder port 8 in the phase #2, #4, #6, or #8 and the second recess 19 (see FIG. 3) is increased.

### Relationship of Cylinder Ports with First Recess and Second recess—5

It is assumed that the cylinder block 2 is driven to rotate in the rotation direction A1 from the state shown in FIG. 4, and the center B1 (see FIG. 2) of the cylinder chamber 6 in the phase #3, #5, or #7 is located on the virtual line H1 in the first dead center portion 16 as shown in FIG. 7.

In the state shown in FIG. 7, the center F1 (see FIG. 2) of the cylinder port 8 in the phase #3, #5, or #7 is located on the lagging side (upstream side) in the rotation direction A1 relative to the virtual line H1 in the first dead center portion 16 by a phase angle difference θ3, θ5, or θ7. The cylinder port 8 in the phase #3, #5, or #7 is separated from the first port 13, and the connection portion between the cylinder port 8 in the phase #3, #5, or #7 and the first recess 18 is increased.

Likewise, also in the case where the center B1 of the cylinder chamber 6 in the phase #3, #5, or #7 has reached the virtual line H1 in the second dead center portion 17 (see FIG. 3), the cylinder port 8 in the phase #3, #5, or #7 is separated from the second port 23, and the connection portion between the cylinder port 8 in the phase #3, #5, or #7 and the second recess 19 (see FIG. 3) is increased.

### First Alternative Embodiment of the Present Invention

In the case where FIGS. 1 to 7 show a hydraulic motor of a continuously variable hydrostatic transmission including a hydraulic pump and a hydraulic motor, the swash plate 4 is fixed at the forward rotation position For the reverse rotation position R.

A state in which the swash plate 4 is fixed at the forward rotation position F, and high pressure hydraulic fluid is supplied to the first ports 11, 12, and 13 will be described below.

When a cylinder chamber 6 and the corresponding piston 7 are located on the virtual line H1 in the second dead center portion 17 relative to the port block 3 (port plate 15), the piston 7 is located toward the cylinder port 8 (see the lower piston 7 in FIG. 1).

The high-pressure hydraulic fluid flows from the first ports 11, 12, and 13 into the cylinder chamber 6 through the cylinder port 8, and the high-pressure hydraulic fluid causes the piston 7 to move in a direction away from the cylinder port 8, and the pressure in the first ports 11, 12, and 13 is increased. As a result of the piston 7 moving in a direction away from the cylinder port 8, the cylinder block 2 is driven to rotate in the rotation direction A1 (see FIG. 2), and power in the rotation direction A1 is output from the drive shaft 1.

In response to the cylinder chamber 6 and the piston 7 moving along the second ports 21, 22, and 23 from the virtual line H1 in the first dead center portion 16, the piston 7 moves in a direction toward the cylinder port 8.

During this period, the low pressure hydraulic fluid in the cylinder chamber 6 flows out to the second ports 21, 22, and 23 through the cylinder port 8, and the pressure in the second ports 21, 22, and 23 is reduced.

With the foregoing configuration, the swash plate 4 causes the cylinder block 2 to be driven to rotate in such a manner that the piston 7 is driven to be reciprocated as a result of hydraulic fluid being supplied to or discharged from the cylinder chamber 6.

### Second Alternative Embodiment of the Present Invention

In the case where FIGS. 1 to 7 show a hydraulic motor of a continuously variable hydrostatic transmission including a hydraulic pump and a hydraulic motor, the swash plate 4 is fixed at the reverse rotation position R, and high-pressure hydraulic fluid is supplied to the first ports 11, 12, and 13, a state opposite to the state described in First Alternative Embodiment of the Present Invention above occurs as described below.

The high-pressure hydraulic fluid flows from the first ports 11, 12, and 13 into the cylinder chamber 6 through the cylinder port 8, and the high-pressure hydraulic fluid causes the piston 7 to move in a direction away from the cylinder port 8. The cylinder block 2 is driven to rotate in a direction opposite to the rotation direction A1 (see FIG. 2), and power in the direction opposite to the rotation direction A1 is output from the drive shaft 1.

In response to the cylinder chamber 6 and the piston 7 moving along the second ports 21, 22, and 23 from the virtual line H1 in the second dead center portion 17, the piston 7 moves in a direction toward the cylinder port 8, and low pressure hydraulic fluid in the cylinder chamber 6 flows out to the second ports 21, 22, and 23 through the cylinder port 8.

With the foregoing configuration, the swash plate 4 causes the cylinder block 2 to be driven to rotate in such a manner that the piston 7 is driven to be reciprocated as a result of hydraulic fluid being supplied to or discharged from the cylinder chamber 6.

### Third Alternative Embodiment of the Present Invention

In the case where FIGS. 1 to 7 show a hydraulic motor of a continuously variable hydrostatic transmission including a hydraulic pump and a hydraulic motor, the swash plate 4 is fixed at the forward rotation position F or the reverse rotation position R.

A state in which the swash plate 4 is fixed at the forward rotation position F, and high-pressure hydraulic fluid is supplied to the second ports 21, 22, and 23 will be described below.

When a cylinder chamber 6 and the corresponding piston 7 are located on the virtual line H1 in the second dead center portion 17 relative to the port block 3 (port plate 15), the piston 7 is located toward the cylinder port 8 (see the lower piston 7 in FIG. 1).

The high-pressure hydraulic fluid flows from the second ports 21, 22, and 23 into the cylinder chamber 6 through the cylinder port 8, and the high-pressure hydraulic fluid causes the piston 7 to move in a direction away from the cylinder port 8, and the pressure in the second ports 21, 22, and 23 is increased. As a result of the piston 7 moving in a direction away from the cylinder port 8, the cylinder block 2 is driven to rotate in a direction opposite to the rotation direction A1 (see FIG. 2), and power in the direction opposite to the rotation direction A1 is output from the drive shaft 1.

In response to the cylinder chamber 6 and the piston 7 moving along the first ports 11, 12, and 13 from the virtual line H1 in the first dead center portion 16, the piston 7 moves in a direction toward the cylinder port 8.

During this period, the low pressure hydraulic fluid in the cylinder chamber 6 flows out to the first ports 11, 12, and 13 through the cylinder port 8, and the pressure in the first ports 11, 12, and 13 is reduced.

With the foregoing configuration, the swash plate 4 causes the cylinder block 2 to be driven to rotate in such a manner that the piston 7 is driven to be reciprocated as a result of hydraulic fluid being supplied to or discharged from the cylinder chamber 6.

### Fourth Alternative Embodiment of the Present Invention

In the case where FIGS. 1 to 7 show a hydraulic motor of a continuously variable hydrostatic transmission including a hydraulic pump and a hydraulic motor, the swash plate 4 is fixed at the reverse rotation position R, and high-pressure hydraulic fluid is supplied to the second ports 21, 22, and 23, a state opposite to the state described in Third Alternative Embodiment of the Present Invention above occurs as described below.

The high-pressure hydraulic fluid flows from the second ports 21, 22, and 23 into the cylinder chamber 6 through the cylinder port 8, and the high-pressure hydraulic fluid causes the piston 7 to move in a direction away from the cylinder port 8. The cylinder block 2 is driven to rotate in the rotation direction A1 (see FIG. 2), and power in the rotation direction A1 is output from the drive shaft 1.

In response to the cylinder chamber 6 and the piston 7 moving along the first ports 11, 12, and 13 from the virtual line H1 in the second dead center portion 17, the piston 7 moves in a direction toward the cylinder port 8, and low pressure hydraulic fluid in the cylinder chamber 6 flows out to the first ports 11, 12, and 13 through the cylinder port 8.

With the foregoing configuration, the swash plate 4 causes the cylinder block 2 to be driven to rotate in such a manner that the piston 7 is driven to be reciprocated as a result of hydraulic fluid being supplied to or discharged from the cylinder chamber 6.

### Fifth Alternative Embodiment of the Present Invention

In the cylinder block 2 shown in FIG. 2, the centers B1 of all of the cylinder chambers 6 may coincide with the centers F1 of the corresponding cylinder ports 8, and the phases #1 to #9 may coincide with the arrangement virtual lines G1 to G9, respectively, of all of the cylinder ports 8. With this configuration, the arrangement pitches E1 to E9 all have the same value.

### Sixth Alternative Embodiment of the Present Invention

In the cylinder block 2 shown in FIG. 2, the arrangement pitches E1 to E9 may be set in the manner described below.

The arrangement pitches E1 to E7 can be set to values that are equal to each other. The arrangement pitches E8 and E9 can be set to values that are different from each other and different from the values of the arrangement pitches E1 to E7.

The arrangement pitches E1 to E5 can be set to values that are equal to each other. The arrangement pitches E6 to E9 can be set to values that are equal to each other and different from the values of the arrangement pitches E1 to E5.

The arrangement pitches E1, E3, E5, E7, and E9 can be set to values that are equal to each other. The arrangement pitches E2, E4, E6, and E8 can be set to values that are equal to each other and different from the values of the arrangement pitches E1, E3, E5, E7, and E9.

The arrangement pitches E1 to E3 can be set to values that are equal to each other. The arrangement pitches E4 to E6 can be set to values that are equal to each other. The arrangement pitches E7 to E9 can be set to values that are equal to each other. The arrangement pitches E1 to E3, the arrangement pitches E4 to E6, and the arrangement pitches E7 to E9 can be set to values different from each other.

With the foregoing configurations, on the arrangement virtual lines G1 to G9 that pass through the center F1, in rotation direction A1, of the cylinder block 2 of the cylinder port 8 and the axis P1 (rotation axis), the arrangement pitches E1 to E9 that are the spaces between the arrangement virtual lines G1 to G9 of the adjacent cylinder ports 8 include the arrangement pitches E1 to E9 that are different from each other.

### Seventh Alternative Embodiment of the Present Invention

The first recess 18 may be provided in the port block 3 (port plate 15), and the second recess 19 may be omitted therefrom.

The second recess 19 may be provided in the port block 3 (port plate 15), and the first recess 18 may be omitted therefrom.

### Eighth Alternative Embodiment of the Present Invention

In the configuration shown in FIG. 3, when an extension line is extended from the first recess 18 toward the upstream side along the longitudinal direction of the first recess 18 (see the virtual circle C1), the virtual line reaches (intersects) the first port 13. In this case, the shape of the first recess 18 may be set in such a manner that the extension line from the first recess 18 does not intersect the first port 13.

### Ninth Alternative Embodiment of the Present Invention

In the configuration shown in FIG. 3, when an extension line is extended from the second recess 19 toward the upstream side along the longitudinal direction of the second recess 19 (see the virtual circle C1), the virtual line reaches (intersects) the second port 23. In this case, the shape of the second recess 19 may be set in such a manner that the extension line from the second recess 19 does not intersect the second port 23.

### Tenth Alternative Embodiment of the Present Invention

The cylinder block 2 may include eight cylinder chambers 6 and pistons 7, or may include seven or six cylinder chambers 6 and pistons 7.

The cylinder block 2 may include ten cylinder chambers 6 and pistons 7, or may include eleven or twelve cylinder chambers 6 and pistons 7.

### INDUSTRIAL APPLICABILITY

The present invention is applicable to an axial piston device for use as, for example, a hydraulic pump and a hydraulic motor of a continuously variable hydrostatic transmission.

### DESCRIPTION OF REFERENCE SIGNS

2: Cylinder block
3: Port block
4: Swash plate
6: Cylinder chamber
7: Piston
8: Cylinder port
11: First port
12: First port
13: First port
15: Port plate (supply and discharge port surface section)
16: First dead center portion
17: Second dead center portion
18: First recess (recess)
19: Second recess (recess)
21: Second port
22: Second port
23: Second port
A1: Rotation direction
E1 to E9: Arrangement pitch
F: Forward rotation position
F1: Center
G1 to G9: Arrangement virtual line
H1: Virtual line
L2: Length
1: Axis (rotation axis)
R: Reverse rotation position

1. An axial piston device, comprising:
a port block;
a cylinder block that is rotatable relative to the port block; and
a swash plate, wherein
the port block includes: a supply and discharge port surface section with which the cylinder block is configured to come into contact while rotating; a first port in a portion of the supply and discharge port surface section which portion is located on a first side of a virtual line passing through a rotation axis of the cylinder block at a right angle; and a second port in a portion of the supply and discharge port surface section which portion is located on a second side of the virtual line,
the cylinder block includes: a cylinder port surface configured to come into contact with the supply and discharge port surface section; a plurality of cylinder chambers; a plurality of pistons provided inside the respective cylinder chambers in such a manner as to be reciprocable along the rotation axis; and a plurality of cylinder ports extending from the cylinder port surface to the respective cylinder chambers,
the swash plate is configured to: in response to the cylinder block being driven to rotate, guide the pistons in such a manner as to cause the pistons to be driven to be reciprocated; or cause the pistons to be driven to be reciprocated as a result of hydraulic fluid being supplied to or discharged from the cylinder chambers to cause the cylinder block to be driven to rotate,
the cylinder ports in a phase to face the first port cause the pistons to move in a direction away from the cylinder ports to cause the hydraulic fluid to flow from the first port into the cylinder chambers through the respective cylinder ports,
the cylinder ports in a phase to face the second port cause the pistons to move toward the cylinder ports to cause the hydraulic fluid to flow out of the cylinder chambers through the respective cylinder ports to the second port,
the virtual line extends through (i) a first dead center portion that is between the first port and the second port and that is on a first side and (ii) a second dead center portion that is between the first port and the second port and that is on a second side, and
the supply and discharge port surface section has in at least one of the first dead center portion and the second dead center portion at least one recess extending from a first one of the first port and the second port, the first one being located on a downstream side in a rotation direction of the cylinder block, toward an upstream side in the rotation direction of the cylinder block.

2. The axial piston device according to claim 1, wherein
the at least one recess has a dimension along the rotation direction of the cylinder block which dimension allows the cylinder ports to be connected both to a second one of the first port and the second port, the second one being located on the upstream side in the rotation direction of the cylinder block, and to the at least one recess.

3. The axial piston device according to claim 1, wherein,
virtual arrangement lines extending through respective centers of the cylinder ports in the rotation direction of the cylinder block and the rotation axis have, as spaces between arrangement virtual lines of adjacent ones among the cylinder ports, arrangement pitches at least one of which is different from another.

4. The axial piston device according to claim 1, wherein,
virtual arrangement lines extending through respective centers of the cylinder ports in the rotation direction of the cylinder block and the rotation axis have, as spaces between arrangement virtual lines of adjacent ones among the cylinder ports, arrangement pitches all of which are different from one another.

5. The axial piston device according to claim 1, wherein
the at least one recess includes a recess at the first dead center portion and a recess at the second dead center portion.

6. The axial piston device according to claim 5, wherein
the cylinder block is drivable to rotate in one direction by external power,
the swash plate is configured, in response to the cylinder block being driven to rotate, guide the pistons in such a manner as to cause the pistons to be driven to be reciprocated, and
the swash plate is switchable between a forward rotation position at which the cylinder ports in the phase to face the first port cause the pistons to move in the direction away from the cylinder ports, and the cylinder ports in the phase to face the second port cause the pistons to move in the direction toward the cylinder ports, and a reverse rotation position at which the cylinder ports in the phase to face the first port cause the pistons to move in the direction toward the cylinder ports, and the cylinder ports in the phase to face the second port cause the pistons to move in the direction away from the cylinder ports.
